(19) United States
(12) Patent Application Publication
(10) Pub. No.: US 2002/0116265 A1
(43) Pub. Date: Aug. 22, 2002

(54) Method and apparatus for in-store media advertising

(76) Inventor: Ruben Hernandez, Los Angeles, CA (US)

Correspondence Address: CHRISTIE, PARKER & HALE, LLP, 350 WEST COLORADO BOULEVARD, SUITE 500, PASADENA, CA, 91105, US

(21) Appl. No.: 10/035,345

(22) Filed: Dec. 28, 2001

Related U.S. Application Data
(60) Provisional application No. 60/258,779, filed on Dec. 28, 2000.
(60) Provisional application No. 60/280,959, filed on Apr. 2, 2001.

(51) Int. Cl. G06F 17/60

(52) U.S. Cl. 705/14

(57) ABSTRACT

A method and apparatus for networked in-store media advertising. A local media advertising system is operably coupled to a media content server via a communications network such as the Internet. The local media advertising system receives advertising content and an advertising content display schedule from the content server. The local media advertising system displays the advertising content according to the advertising content display schedule. The local media advertising system has a viewer sensor that the local media advertising system uses to compile viewer data about the number of viewers and customers in the vicinity of the displayed media content. The local media advertising system generates viewer information about how many viewers and customers were in the vicinity of the displayed advertising content using the viewer data and the advertising content display schedule. The local media advertising system then transmits the viewer information to a statistics server via the communications network. Advertisers can then retrieve the viewer information from the statistics server in order to monitor the effectiveness of an advertising campaign.

### CROSS-REFERENCE TO RELATED APPLICATION

This application claims the benefit of U.S. Provisional Application No. 60/258,779 filed on Dec. 28, 2000, and U.S. Provisional Patent Application 60/280,957 filed Apr. 2, 2001 which are hereby incorporated by reference as if set forth in full herein.

### BACKGROUND OF THE INVENTION

This invention relates generally to the field of advertising systems and more particularly tracking of presentation of advertising content to an audience within a known physical location.

Advertisers typically design advertising content for presentation to an audience of a desired demographic profile. Most advertisers seek out the most suitable broadcast medium for their advertising content based on matching the desired demographic profile to a broadcaster's claims about the size and demographic profile of the broadcaster's typical audience. Broadcasters in turn attempt to attract the largest possible audience and expend considerable effort in determining the size and demographic profile of a resultant audience. For example, television broadcasters seek out programming content appealing to a particular audience fitting a particular demographic profile. Once a television broadcaster selects programming content for broadcast, the television broadcaster expends additional effort to determine the size and actual demographic profile of the viewing audience reached by the programming content. The larger the size of an audience fitting a desired demographic profile, the more a broadcaster can charge an advertiser for carrying the advertiser's advertising content.

However, broadcasters often fall short of selecting proper programming content for a particular audience demographic. Sometimes the programming content fails to attract a large audience. At other times, the audience attracted to a particular program does not fit the broadcaster's expected demographic profile. In these cases, an advertiser may not be willing to pay a premium for the broadcaster's services if the advertiser believes the broadcaster does not attract a large audience fitting a desired demographic profile.

Furthermore, many broadcast mediums reach an audience of uncertain size. For example, television commercials are broadcast over a television channel for reception by a television receiver. Whether or not a television receiver has an audience when the television receiver is receiving the broadcast is difficult to determine. In this case, a broadcaster must resort to indirect sampling means and use statistically based extrapolations to estimate the size of an audience for a particular broadcast. While often accurate, the indirect sampling means and extrapolations are expensive procedures that require time consuming data collection and analysis steps.

The problems of collecting and analyzing audience size and demographics are become even more difficult in the cases of a new medium. Television and radio broadcasters can rely on independently run and well established organizations to collect data on audience size and demographic profiles. However, new mediums, such as in-store advertising, do not have well established measurement systems in place for advertisers and broadcasters to determine a broadcaster's ability to reach a particular audience.

Therefore a need exists to establish the demographic profile and size of a broadcaster's audience. The present invention meets such need.

### SUMMARY OF THE INVENTION

In one aspect of the invention, a method and apparatus is provided for networked in-store media advertising. A local media advertising system is operably coupled to a media content server via a communications network such as the Internet. The local media advertising system receives advertising content and an advertising content display schedule from the content server. The local media advertising system displays the advertising content according to the advertising content display schedule. The local media advertising system has a viewer sensor that the local media advertising system uses to compile viewer data about the number of viewers and customers in the vicinity of the displayed media content. The local media advertising system generates viewer information about how many viewers and customers were in the vicinity of the displayed advertising content using the viewer data and the advertising content display schedule. The local media advertising system then transmits the viewer information to a statistics server via the communications network. Advertisers can then retrieve the viewer information from the statistics server in order to monitor the effectiveness of an advertising campaign.

In another aspect of the invention, advertising content and viewer information are received and transmitted by an advertising system operably coupled to a content server and a statistics server via a communications network. The advertising system receives from the content server via the communications network advertising content and an advertising content display schedule. The advertising system displays the advertising content according to the advertising content display schedule while receiving viewer signals indicating the number of viewers available to view the advertising content. The advertising system generates viewer information using the viewer signals and the advertising content display schedule and transmits the viewer information to the statistics server via the communications network.

In another aspect of the invention, the advertising system receives sales data while displaying the advertising content and generates sales information using the sales data and the advertising content display schedule.

In another aspect of the invention, an advertising system includes means for receiving advertising content and an advertising content display schedule from a content server, means for displaying the advertising content according to the advertising content display schedule, means for receiving viewer signals while displaying the advertising content, means for generating viewer information using the viewer signals and the advertising content display schedule, and means for transmitting the viewer information to a statistics server.

In another aspect of the invention, a networked media advertising system includes a content server and a statistics server operably coupled via a communications network such as the Internet to an advertising system. The advertising system includes an advertising controller, an advertising display device operably coupled to the advertising controller, and a viewer sensor operably coupled to the advertising controller.

### BRIEF DESCRIPTION OF THE DRAWINGS

The features, aspects, and advantages of the present invention will become better understood with regard to the following detailed description, accompanying drawings, and appendix where:

FIG. 1 is a network diagram depicting an embodiment of an in-store media advertising system in accordance with the present invention;

FIG. 2 is a network diagram depicting a single in-store system in accordance with the present invention;

FIG. 3 is a hardware architecture diagram for a STB as described in FIG. 2;

FIG. 4 is a hardware architecture diagram for a general purpose computer suitable for use as a host of an in-store media advertising server as described in FIG. 2;

FIG. 5 is collaboration diagram depicting the data flow within an in-store media advertising system in accordance with the present invention;

FIG. 6 is a sequence diagram depicting an exemplary communication and operation sequence of the objects of FIG. 5;

FIG. 7 is a sequence diagram depicting the retrieval of advertising statistics from a statistics server by an advertiser;

FIG. 8 is a process flow diagram of calculating advertising statistics by a statistics server; and

FIG. 9 is a block diagram depicting a customer sensor in accordance with the present invention.

### DETAILED DESCRIPTION

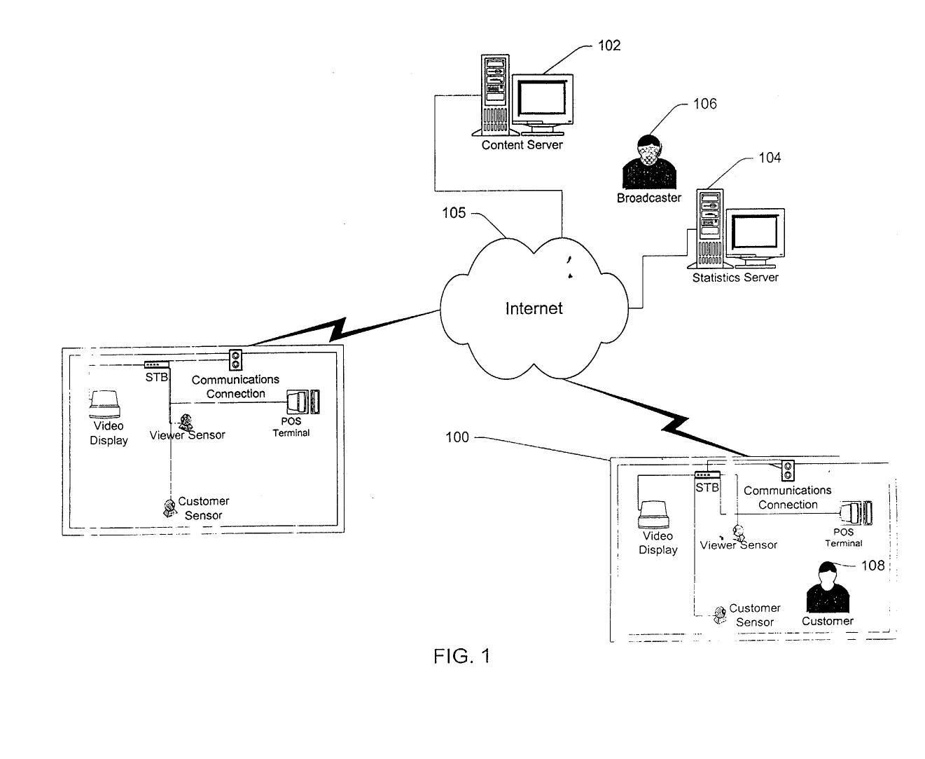

FIG. 1 is a network diagram depicting an embodiment of a networked media advertising system in accordance with the present invention. A networked media advertising system includes at least one local advertising system including such as in-store system 100, at least one content server 102, and at least one statistical server 104 operably coupled via a communications network such as the Internet 105. In operation, a broadcaster 106 provides advertising content to the in-store system using the content server. The in-store system displays the advertising content to a customer 108. The in-store system monitors the customer and transmits data about the customer to the statistics server.

In slightly more detail, the content server provides a user interface for submission by the broadcaster of advertising content. The broadcaster submits advertising content as well as scheduling information to the content server. The content server formats the advertising content for use by the in-store system. The content server then transmits to the in-store system the advertising content and the scheduling information. The in-store system uses the scheduling information to determine when to display the advertising content to the customer. The in-store system collects information about the number of customers and advertising content viewers that the in-store system detects. The in-store system transmits the information about the customers and advertising content viewers to the statistics server. The statistics server uses the customer and advertising content viewer information as well as scheduling information to generate statistics about how many viewers saw the advertising content.

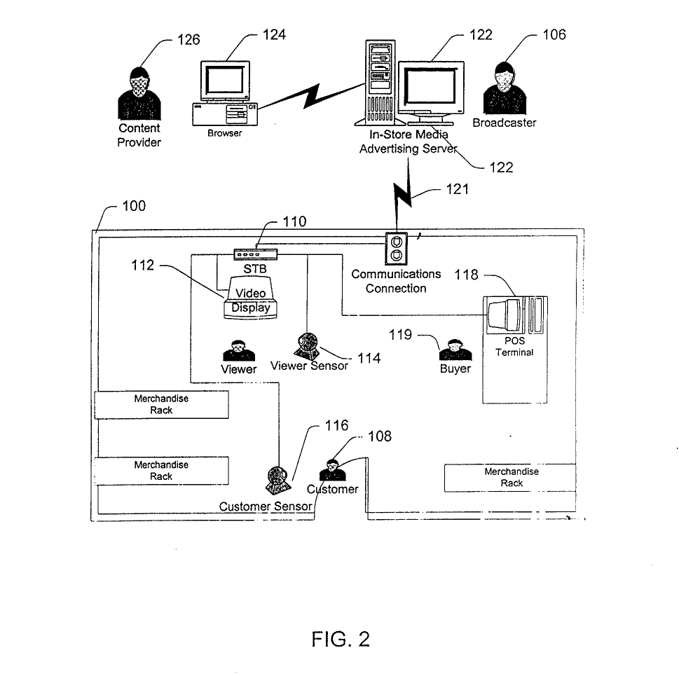

FIG. 2 is a network diagram depicting a single in-store system in accordance with the present invention. An in-store system includes an advertising controller such as a Set Top Box (STB) 110 operably coupled to at least one advertising display device such as a video display 112 and to at least one viewer sensor such as a viewer sensor 114. The STB communicates with an in-store media advertising server 122 via a store communications link 121. The in-store media advertising server includes the previously described content server 102 and a statistics server 104 of FIG. 1. A broadcaster uses the content server portion of the in-store media advertising server to hold advertising content provided by a content provider 126. The content provider uses a browser 124 to access the statistics server portion of the in-store media advertising server.

In operation, the content server portion of the in-store media advertising server receives advertising content from the content provider. The STB requests and receives advertising content from the in-store media advertising server and displays the advertising content to a viewer 120 using the video display. The STB detects how many viewers are in front of the video display using viewer sensor 114. The STB transmits advertising content display information to the statistical server portion of the in-store media advertising server. The advertising content display information includes information about which portion of the advertising content is being displayed and how many viewers are standing in front of the video display. The content provider accesses the advertising content display information stored by the statistical server portion of the in-store media advertising server to determine how many viewers may have viewed the advertising content displayed by the in-store system.

In one embodiment of the invention in accordance with the present invention, the store communications link has a communications network including a computer network such as the Internet. In this embodiment, the STB and the in-store media advertising server communicate with each other using communications protocols including the suite of Internet protocols built upon the Transmission Control Protocol/Internet Protocol (TCP/IP) such as Hyper Text Transfer Protocol (HTTP) for hypertext document transfer. Alternatively, the STB communicates over a proprietary communications network including satellite transmissions.

In an embodiment of the invention in accordance with the present invention, the STB is operably coupled to at least one customer sensor 116. The STB monitors the entry and exit of customers 108 into a store using the customer sensor. Using information collected from a customer sensor, the STB can determine the number of customers in a store at any given moment. This customer information is transmitted to the in-store media advertising server along with the previously described advertising content information.

In another embodiment of the invention in accordance with the present invention, the STB is operably coupled to at least one store sales data collection system such as Point of Sale (POS) terminal 118. The STB collects sales information from the POS terminal about sales made to buyers 119. The sales information is transmitted to the in-store media advertising server along with the previously described advertising content information.

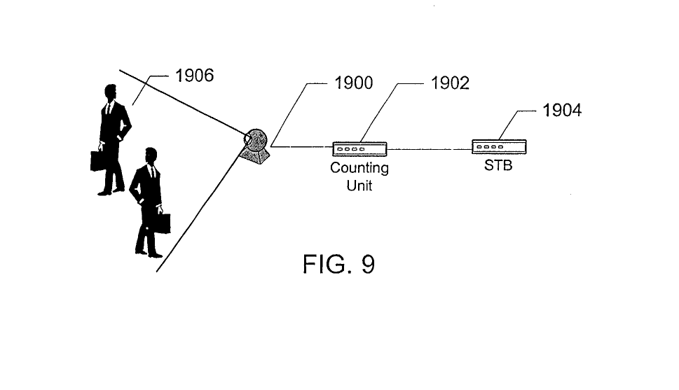

FIG. 9 is a block diagram depicting exemplary an viewer or customer sensor in accordance with the present invention. A viewer or customer sensor such as viewer sensor 1900 is operably coupled to a counting unit 1902. The counting unit is operably coupled to a STB 1904. In operation the viewer sensor generates viewer detection signals in response to viewers 1906 within the detection range of the viewer sensor. The viewer sensor transmits the viewer detection signals to the counting unit. The counting unit receives the viewer detection signals and generates a viewer signal using the viewer detection signals. The counting unit then transmits the viewer signal to the STB.

In one embodiment of a counting unit in accordance with the present invention, the counting unit generates a viewer signal by summing up the number of viewer detection signals received by the counting unit over a period of time.

In one embodiment of a viewer sensor, the viewer sensor detects viewers without discriminating between incoming and outgoing viewers. In this embodiment, the counting unit receives the viewer detection signals and divides by two to determine the total number of viewers in a location.

In another embodiment of a viewer sensor, the viewer sensor discriminates between incoming and outgoing viewers. In this embodiment, the viewer detection signal includes a directional component indicating the direction of movement of the viewer. The counting unit in this embodiment generates viewer signals including a directional component.

A suitable viewer sensor is a model number IRM01 ceiling mounted active infrared matrix sensor and a suitable counting unit is a model number RTC801 counting unit both manufactured by Prodco Technology of Toronto, Canada.

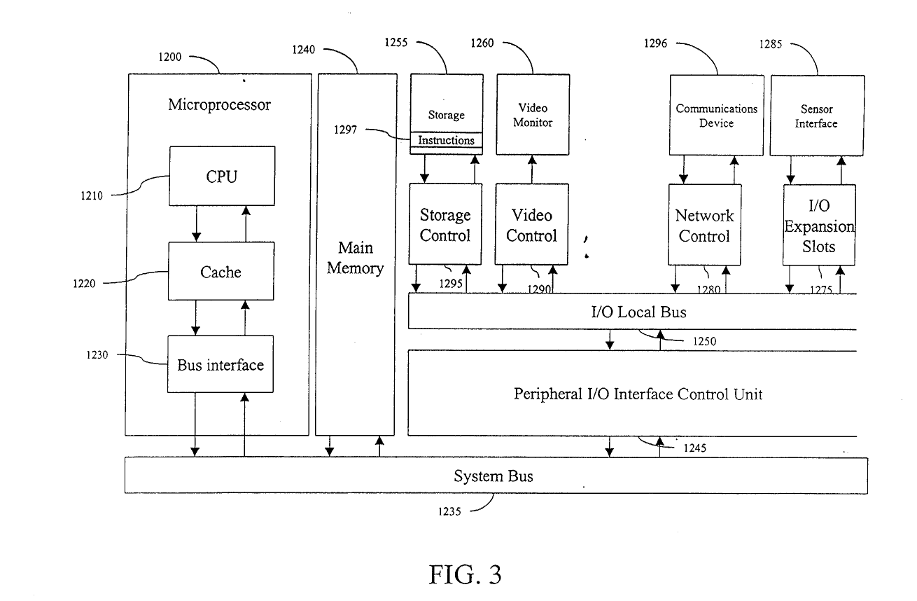

FIG. 3 is a hardware architecture diagram of an exemplary STB in accordance with the present invention. A STB includes a microprocessor 1200, comprised of a Central Processing Unit (CPU) 1210, a memory cache 1220, and a bus interface 1230. The bus interface is operatively coupled via a system bus 1235 to a main memory 1240 and an Input/Output (I/O) interface control unit 1245. The I/O interface control unit is operatively coupled via I/O local bus 1250 to a storage controller 1295, a video controller 1290, a network controller 1280, and I/O expansion slots 1275.

A communications device 1296 operably coupled to the network controller is adapted to allow software objects hosted by the STB to communicate via a network with remotely hosted software objects.

The storage controller is operatively coupled to a storage device 1225 for permanent storage of processor instructions 1297 and data 1298. The data includes advertising content for output by the STB and the previously described advertising content information.

The video controller is operatively coupled to a video monitor 1260. The STB uses the video controller to send advertising content to the video monitor for display. Exemplary video monitors suitable for use by the STB are depicted in Appendix B which is incorporated by reference as if fully stated herein.

A sensor interface 1285 is operably coupled to an I/O expansion slot. The STB uses the sensor interface to couple with the previously described viewer and customer sensors.

Processor instructions 1297 implementing the software functions of a STB are stored on the disk storage device until the microprocessor retrieves the processor instructions and stores them in the main memory. The microprocessor then executes the processor instructions stored in the main memory to implement the functions of a STB.

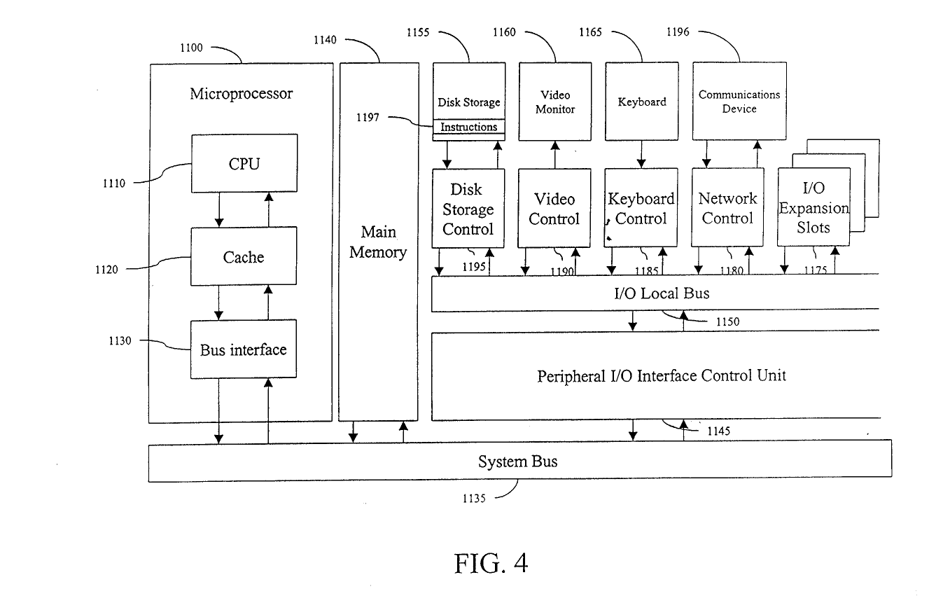

FIG. 4 is a hardware architecture diagram for a general purpose computer suitable for use as a host of an in-store media advertising server as described in FIG. 2. A general purpose computer includes a microprocessor 1100, comprised of a Central Processing Unit (CPU) 1110, a memory cache 1120, and a bus interface 1130. The bus interface is operatively coupled via a system bus 1135 to a main memory 1140 and an Input/Output (I/O) interface control unit 1145. The I/O interface control unit is operatively coupled via I/O local bus 1150 to a storage controller 1195, a video controller 1190, a network controller 1180, and I/O expansion slots 1175.

A communications device 1196 operably coupled to the network controller is adapted to allow software objects hosted by the general purpose computer to communicate via a network with remotely hosted software objects.

The storage controller is operatively coupled to a storage device 1125 for permanent storage of processor instructions 1197 and data 1198. The data includes advertising content for use by a STB and the previously described advertising content information.

The video controller is operatively coupled to a video monitor 1160. The general purpose computer uses the video monitor to display information to a user.

The keyboard controller is operably coupled to a keyboard 1165. The general purpose computer receives user inputs via the keyboard.

Processor instructions 1197 implementing the software functions of the previously described content server and statistical server are stored on the disk storage device until the microprocessor retrieves the processor instructions and stores them in the main memory. The microprocessor then executes the processor instructions stored in the main memory to implement the functions of a content server or a statistical server.

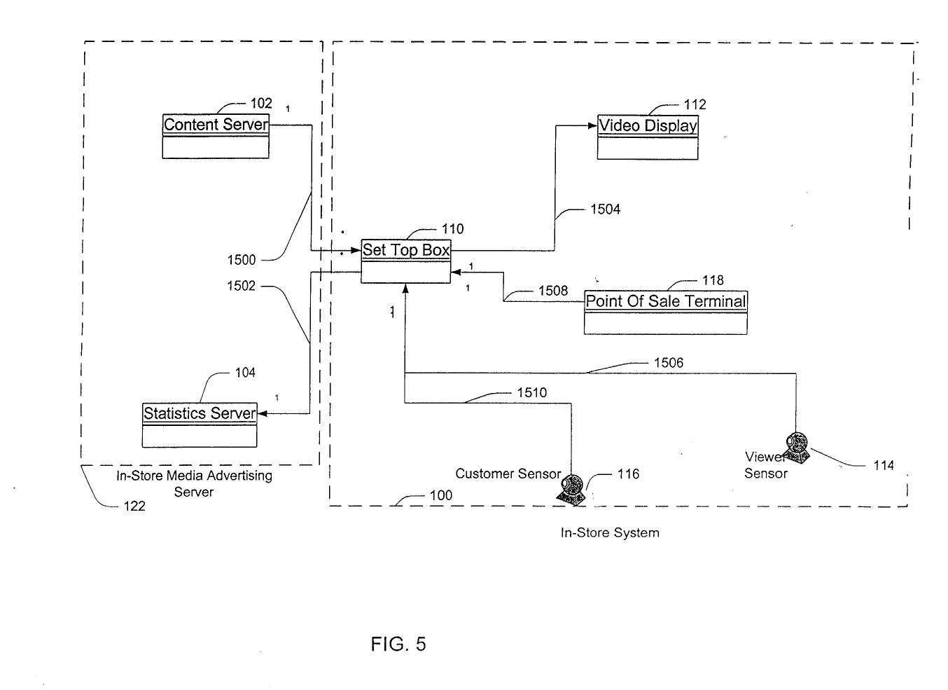

FIG. 5 is collaboration diagram depicting the data flow within an exemplary embodiment of an in-store media advertising system in accordance with the present invention. A previously described in-store system 100 is operably coupled to a previously described remotely hosted in-store media advertising server 122.

The in-store system includes a STB 110 that receives advertising content and an advertising content playback schedule 1500 from a content server portion 102 of the in-store media advertising server. The STB stores the advertising content in a read and write local storage device such as a hard disk. The STB uses the advertising content playback schedule to determine when the advertising content 1504 should be sent to a video display 112.

A viewer sensor 114 transmits a viewer count signal 1506 to the STB. The viewer count signal corresponds to the number of viewers in the vicinity of the video display at any given instant in time. The STB records the number of viewers in the vicinity of the video display at specific time intervals.

The STB combines viewer sensor information with advertising content scheduling information to create advertising content display information. The advertising content display information includes information about which portion of the advertising content is being displayed and how many viewers are standing in front of the video display at a specific time. The advertising content display information is sent to a statistics server 104 for further processing.

In an another embodiment of an in-store system in accordance with the present invention, the STB combines information from a point of sale terminal 118 with the advertising content display information before the advertising content display information is sent to the statistics server.

In an another embodiment of an in-store system in accordance with the present invention, the STB combines information taken from customer sensor 116 and combines it with the advertising content display information. The customer sensor produces a signal 1510 proportional to the number of customers within a store served by the in-store system.

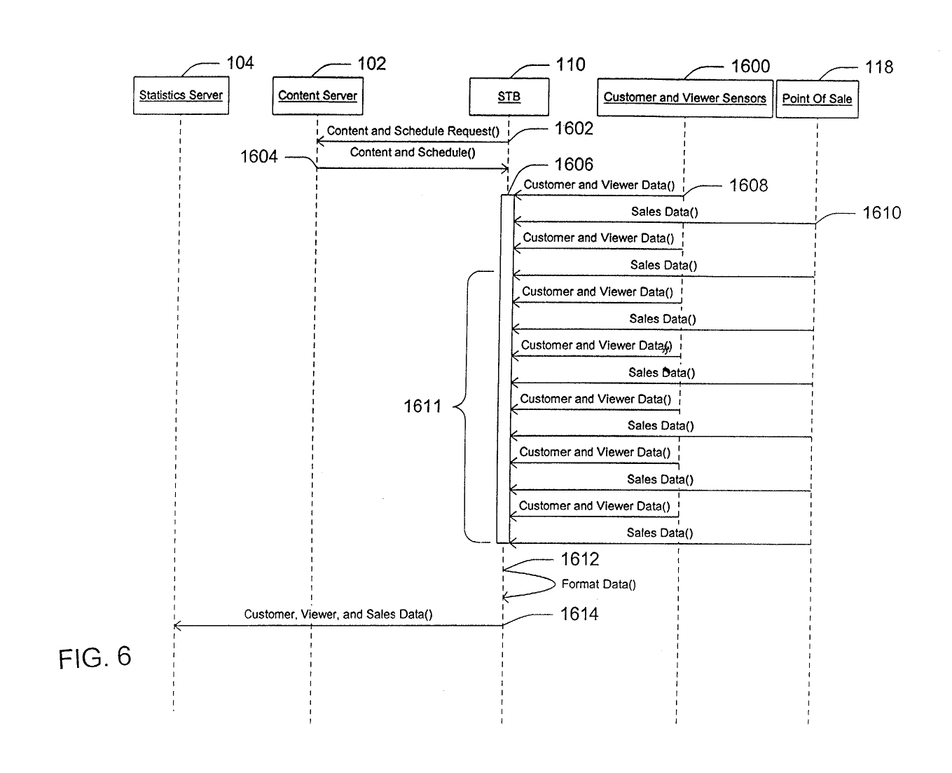

FIG. 6 is a sequence diagram depicting an exemplary communication and operation sequence of the exemplary objects of FIG. 5. An STB 110 transmits an advertising and scheduling request 1602 to a content server 102. The content server transmits advertising content and scheduling information 1604 to the STB. The STB uses the scheduling information to determine when portions of the advertising content should be played on an advertising content output system such a video display.

The STB displays 1606 advertising content according to the scheduling information. During the display process, the STB collects customer and viewer data 1608 from customer and viewer sensors 1600. The viewer data contains information about how many viewers are within the vicinity of a video display used by the STB to display the advertising content. The customer sensors sense the number of customers entering and leaving a store served by the STB.

The STB collects sales data 1610 from a point of sale device 118 during the time the STB is displaying advertising content. The sales data includes the number of transactions completed, the value of the transactions, and an indication of the actual products sold during the transaction such as a product's Universal Product Code (UPC).

The STB continues to collect 1611 customer, viewer, and sales data while the STB is displaying advertising content. The STB formats 1612 the collected data and transmits the collected data 1614 to a statistics server for use by a content provider.

In one embodiment of an in-store system in accordance with the present invention, a customer sensor is placed at the entrance to the store. The customer sensor senses when a customer enters or leaves the store using the entrance. In this case, a customer is registered by the sensor twice, once when the customer enters the store, and once when the customer leaves the store. In this case, the total number of customers visiting the store during a day can be estimated by dividing the number of times the customer sensor sensed a customer and dividing that number by two.

In another embodiment an in-store system in accordance with the present invention, the customer sensor is configured to sense the direction that a customer is moving when the customer is sensed. For example, the customer sensor is placed at an entrance to a store and if a customer walks into the store using the entrance, the sensor transmits an entrance signal to the STB indicating that a customer came into the store. If a customer walks out of the store using the entrance, the customer sensor transmits an exit signal to the STB indicating that a customer has left the store. The STB determines the number of customers in the store at any given time by subtracting the number of exit signals the STB received from the number of entrance signals the STB received.

In another embodiment of a viewer sensor included in an in-store system in accordance with the present invention, a video camera is used to capture images of viewers in the vicinity of a video display device displaying advertising content. The images are analyzed by the STB to determine the demographic distribution of the viewers such as the ratio of males to females viewing the advertising content. Alternatively, the images are sent to the statistics server as part of the viewer data so that the images can be analyzed to reveal viewer demographics by the broadcaster and the content provider.

In another embodiment of an in-store system in accordance with the present invention, the advertising content and scheduling data is not loaded into the STB as a single unit, instead the STB receives the advertising content from streaming sources such as a streaming server. In this embodiment, the STB receives scheduling information from a content server. The STB uses the scheduling information to request streaming content from the streaming server.

In another embodiment of an in-store system in accordance with the present invention, the STB combines advertising content received from different content servers to create content for display on a video device. For example, the STB receives video based advertising content encoded in a digital format such as MPEG4 such as a television commercial from one content server and receives digital advertising content such as an Internet banner advertisement from another advertising content server. The STB combines the two contents to create a single advertising content provided to a video display. Alternatively, the STB combines in-store information such as an in-store promotion with the advertising content.

In another embodiment of an in-store system in accordance with the present invention, the advertising content display is accomplished through a video display system including viewer input capabilities. For example, the video display system is housed in a kiosk that a viewer can reach. In this way, interactive advertising content can be displayed by the STB and the STB can record viewer interactions with the interactive advertising content for transmission to the statistics server.

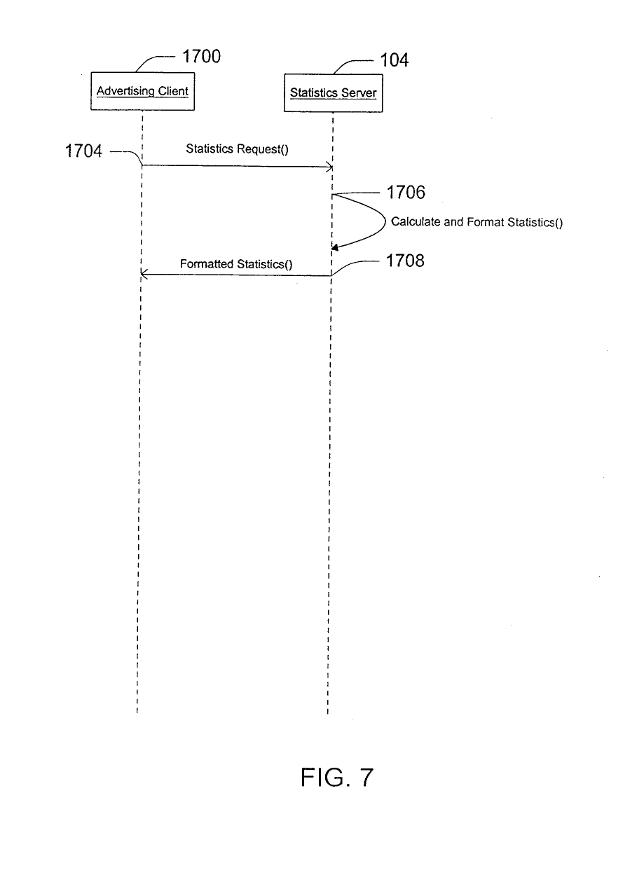

FIG. 7 is a sequence diagram depicting an exemplary retrieval process of advertising statistics from an exemplary statistics server by an advertiser in accordance with the present invention. An advertiser uses an advertising client 1700 to send a statistics request 1704 to a statistics server 104. The statistics request includes an advertiser identifier used by the statistics server to find customer and viewer data from stores to which the advertiser's content was sent. The statistics server finds the customer and viewer data from each relevant store and calculates advertising statistics useful in evaluating the effectiveness of an advertising campaign. The statistics server formats the data into a format suitable for transmission to the advertising client and transmits the formatted statistics 1708 to the advertising client for display to the advertiser.

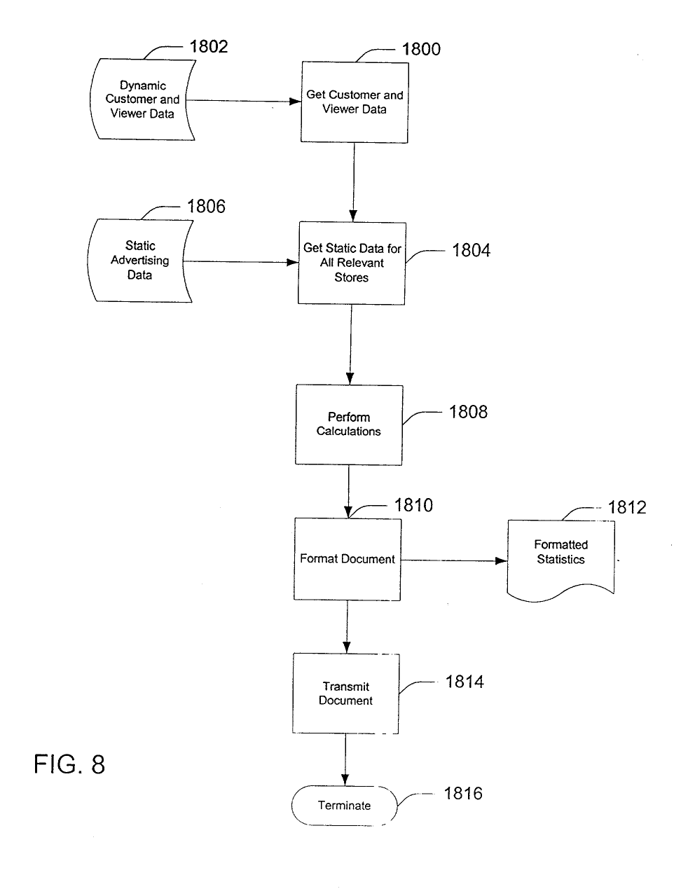

FIG. 8 is a process flow diagram of an exemplary process for calculating advertising statistics by an exemplary statistics server in accordance with the present invention. To calculate statistics for an advertiser, the statistics server gets 1800 the real time customer and viewer data 1802 for the relevant stores. The previously described customer and viewer data comprises real-time data collected from in-store systems. The statistics server gets 1804 the static data associated with a relevant store. The static data includes the fees paid by the advertiser to have advertising content sent to the relevant store. The content server performs calculations 1808 to produce statistical measures of the effectiveness of the advertising placement. The statistics server formats 1810 the statistics into a statistics document 1812 suitable for transmission to a previously described advertiser client. The statistics server transmits 1814 the statistics document to the advertising client and terminates 1816 the process.

Although this invention has been described in certain specific embodiments, many additional modifications and variations would be apparent to those skilled in the art. It is therefore to be understood that this invention may be practiced otherwise than as specifically described. Thus, the present embodiments of the invention should be considered in all respects as illustrative and not restrictive, the scope of the invention to be determined by any claims supportable by this application and the claims' equivalents rather than the foregoing description.

What is claimed is:

1. A method for advertising, comprising:
displaying advertising content according to an advertising content display schedule;
receiving viewer signals while displaying the advertising content; and
generating viewer information using the viewer signals and the advertising content display schedule.

2. The method of claim 1 further comprising receiving the advertising content and the advertising content display schedule from a content server.

3. The method of claim 1 further comprising transmitting the viewer information to a statistics server.

4. The method of claim 1 further comprising:
receiving sales data while displaying the advertising content; and
generating sales information using the sales data and the advertising content display schedule.

5. An apparatus for advertising, comprising:
means for displaying advertising content according to an advertising content display schedule;
means for receiving viewer signals while displaying the advertising content; and
means for generating viewer information using the viewer signals and the advertising content display schedule.

6. The apparatus of claim 5 further comprising means for receiving the advertising content and the advertising content display schedule from a content server.

7. The apparatus of claim 5 further comprising means for transmitting the viewer information to a statistics server.

8. A method for advertising using an advertising system operably coupled to a content server and a statistics server via a communications network, comprising:
receiving by the advertising system from the content server via the communications network advertising content and an advertising content display schedule;
displaying by the advertising system the advertising content according to the advertising content display schedule;
receiving by the advertising system viewer signals while displaying the advertising content;
generating by the advertising system viewer information using the viewer signals and the advertising content display schedule; and
transmitting by the advertising system to the statistics server via the communications network the viewer information.

9. The method of claim 8 wherein the viewer signal further includes a directional component.

10. A networked media advertising system, comprising:
a content server;
a statistics server;
an advertising system operably coupled to the content server and the statistics server via a communications network, the advertising system including:
an advertising controller;
an advertising display device operably coupled to the advertising controller; and
a viewer sensor operably coupled to the advertising controller.
